(19) United States
(12) Patent Application Publication
(10) Pub. No.: US 2024/0132230 A1
(43) Pub. Date: Apr. 25, 2024

(54) Systems, Methods, and Apparatus For Fault Diagnosis Of Systems

(71) Applicant: The Boeing Company, Chicago, IL (US)

(72) Inventors: Partha Adhikari, Chicago, IL (US); Nayan Maiti, Chicago, IL (US); Seema Chopra, Chicago, IL (US); Dragos D. Margineantu, Chicago, IL (US); Darren B. Macer, Chicago, IL (US)

(21) Appl. No.: 17/973,012

(22) Filed: Oct. 24, 2022

(51) Int. Cl. B64F 5/60; G06N 7/01; G07C 5/00; G07C 5/08

(52) U.S. Cl. CPC B64F 5/60; G06N 7/01; G07C 5/006; G07C 5/0808

(57) ABSTRACT

The present application describes an apparatus having a processor configured to receive a plurality of sensor measurements for each sensor of a plurality of sensors of the system. The processor may be configured to compare the plurality of sensor measurements from each sensor to a respective threshold value, determine, based on the comparisons, a condition of the system having a degraded state and one or more conditions of the system having a normal state, and select at least one of the one or more conditions of the system having a normal state. The processor may be configured to input the condition having degraded state and the at least one condition having a normal state into a diagnostic model. Further, the processor may be configured to isolate, using the diagnosis model, a failed or degraded component of the system.

### FIELD

The present disclosure relates generally to fault diagnosis of complex systems, and more particularly to diagnosing and isolating failures of one or more components of a subsystem or system, such as one or more line replacement units (LRUs) or lower level components of an aircraft.

### BACKGROUND

This background description is provided for the purpose of generally presenting the context of the disclosure. Unless otherwise indicated herein, material described in this section is neither expressly nor impliedly admitted to be prior art to the present disclosure or the appended claims.

Maintenance, including the reliable troubleshooting of complex systems, is a common issue in various industries, such as the aircraft industry, the automotive industry, the electronics industry and the like. In the aircraft industry, for example, maintenance of an aircraft is of paramount importance to ensure the continued safe and efficient operation of the aircraft. Aircraft maintenance can occur in several different manners. For example, scheduled maintenance generally includes a number of specific tasks, inspections, and repairs that are performed at predetermined intervals. These events are scheduled in advance and rarely result in aircraft schedule interruption. In contrast, unscheduled maintenance is performed as required to maintain the aircraft's allowable minimum airworthiness during intervals between scheduled maintenance. Unscheduled maintenance is usually performed while the aircraft is on the ground between flights. However, unscheduled maintenance may be performed during a scheduled maintenance check if a mechanic identifies a problem that was not anticipated. Minimum ground time between flights is desirable to maximize airplane utilization and to meet the established flight schedules. Therefore, the time allocated to unscheduled maintenance is often limited to the relatively short time that the aircraft is required to be at the gate in order to permit passengers to unload and load, to refuel, and to otherwise service the aircraft.

Although wireless communications facilitate preflight troubleshooting by allowing pilots to communicate problems (e.g., flight deck effects) to maintenance operators during the last flight leg or while the aircraft is on the ground, it is oftentimes difficult to complete the unscheduled maintenance during preflight timeframes, thereby leading to flight delays and/or cancellations. These flight delays and/or cancellations may be extremely costly to an airline, both in terms of actual dollars and in terms of passenger perception. In this regard, an airline typically begins accruing costs related to a flight delay following the first five minutes of a delay, with substantial costs accruing if the flight must be cancelled. Moreover, as most air passengers are aware, airline dispatch reliability is a sensitive parameter that airlines often use to distinguish themselves from their competitors.

Notwithstanding the critical importance of properly performing unscheduled maintenance in both an accurate and timely manner, mechanics who perform unscheduled maintenance on the flight line may face a difficult challenge. For example, an aircraft usually includes extremely large and complex systems comprised of many interconnected subsystems. Each subsystem is typically comprised of many line replaceable units (LRUs) that are designed to be individually replaced. A LRU may be mechanical, such as a valve or a pump; electrical, such as a switch or relay; or electronic, such as an autopilot or a flight management computer. Many LRUs are, in turn, interconnected. As such, the symptoms described by flight deck effects or other observations may indicate that more than one LRU may be the cause of the symptoms. At that point, there may be ambiguity about which LRU(s) may have actually failed. Additional information may be needed to disambiguate between the possibilities. Further, flights decks may be prone to error or misclassification. For example, misclassifications (e.g., false positives in anomaly detection) can result in needless maintenance activity being scheduled or can result in expensive investigation being performed by aircraft personnel to determine that the detected anomaly was a misclassification. As such, minimizing the number of misclassifications is advantageous. Nevertheless, the ambiguous fault indications discovered during the troubleshooting process may nevertheless need to be resolved before the aircraft can be dispatched.

A mechanic may therefore troubleshoot the problem to identify one or more LRUs that may be faulty or defective, with the number of LRUs preferably being minimized to prevent an excessive number of LRUs that are functioning properly from being replaced. Once the mechanic identifies one or more LRUs that may be faulty or defective, the mechanic may determine if the LRUs are to be repaired or replaced. If a LRU must be replaced, the mechanic removes the LRU, obtains a replacement LRU, and installs the replacement LRU. If the subsystem is capable of being tested while the aircraft is on the ground, the mechanic then generally tests the subsystem to insure that the problem is corrected by the replacement LRU.

Following departure of the aircraft, the LRUs that have been removed are generally tested to determine if the LRUs are defective and, if so, which component(s) of the LRUs failed. These tests frequently determine that many of the LRUs that are replaced are actually functioning properly. The replacement of LRUs that are actually functioning properly increases the costs to maintain the aircraft, both in terms of the cost of the parts and the labor. Additionally, the replacement of LRUs that are functioning properly may cause an excessive number of LRUs to be maintained in inventory, thereby also increasing inventory costs associated with the maintenance of the aircraft.

Accordingly, aircraft maintenance is of critical importance for a number of reasons. Moreover, the performance of aircraft maintenance, especially unscheduled maintenance, in a reliable and timely fashion is desirable in order to minimize any delays or cancellations due to maintenance work. Additionally, it is desirable to fully troubleshoot a problem such that a minimum number of LRUs are replaced in order to reduce the maintenance costs and to permit inventory to be more closely controlled. Further, maintenance operations, especially unscheduled maintenance operations, may include a very complicated troubleshooting process which oftentimes requires a mechanic to reference one or more manuals that outline the process and, even if performed correctly, may require an aircraft to be on the ground in repair for an undesirably long period of time. As such, an improved fault diagnosis or isolation system for identifying the faulty or defective components of an aircraft is desired. This improved fault diagnosis system is especially important for unscheduled maintenance such that the troubleshooting process can be expedited in order to reduce the number of flights that have to be delayed or cancelled as a result of maintenance delays. Similarly, the maintenance of other types of complex systems in other industries is also important and it would also be desirable for any improved fault diagnosis system to be equally applicable to a wide variety of complex systems from different industries, including the automotive, marine, electronics and power generation industries.

### SUMMARY

The present application discloses embodiments that relate to systems, methods, and apparatus for fault diagnosis or isolation of complex systems, such as aircraft systems. The embodiments include techniques for detecting anomalies or adverse conditions of a system and for reliably identifying and/or isolating the failure or degradation of one or more components of the system (e.g., line replacement units (LRU) or lower level internal components within an LRU) that caused the anomalies or adverse conditions of the system. For example, the embodiments may be configured to efficiently analyze operational data (e.g., sensor signals or measurements) to detect anomalies or adverse conditions of a system. Further, the embodiments may be configured to implement a diagnosis model to identify and isolate a failure or degradation of a component based on the conditions or states of the system. As such, the embodiments may facilitate troubleshooting processes of systems in order to decrease the time required to identify and isolate a failed or degraded component of the system.

By efficiently and reliably troubleshooting systems, the embodiments may reduce the number of components that are replaced that are actually functioning properly, thereby decreasing maintenance costs and improving inventory control relative to conventional troubleshooting processes that oftentimes replace components that are still operational. The embodiments may also advantageously increase system reliability, safety, maintainability, availability, and affordability resulting in improved performance and operational capabilities of systems. Further, in the aircraft industry, the embodiments may reduce the number of flights that are delayed or cancelled for unscheduled maintenance.

In one aspect, the present application describes an apparatus comprising a memory and at least one processor. The at least one processor may be configured receive operational data associated with the system, wherein the operational data includes a plurality of sensor measurements for each sensor of a plurality of sensors of the system, and wherein the sensor measurements are indicative of conditions or states of the system. The processor may also be configured to compare the plurality of sensor measurements from each sensor to a respective threshold value, determine, based on the comparisons, a condition of the system having a degraded state and one or more conditions of the system having a normal state, and select at least one of the one or more conditions of the system having a normal state. Further, the processor may be configured to input the condition having degraded state and the at least one condition having a normal state into a diagnostic model, wherein the diagnostic model represents a data structure defining causal relationships between nodes, wherein the data structure includes a plurality of the nodes representing components of the system, and wherein each of the nodes includes a plurality of states. Additionally, the processor may be configured to isolate, using the diagnosis model, a failed or degraded component of the system, and provide a maintenance action for the failed or degraded component.

In another aspect, the present application describes a method. The method may comprise receiving operational data associated with the system, wherein the operational data includes a plurality of sensor measurements for each sensor of a plurality of sensors of the system, and wherein the sensor measurements are indicative of conditions or states of the system. The method may also comprise comparing the plurality of sensor measurements from each sensor to a respective threshold value, determining, based on the comparisons, a condition of the system having a degraded state and one or more conditions of the system having a normal state, and selecting, by the one or more processors, at least one of the one or more conditions of the system having a normal state. Further, the method may comprise inputting the condition having degraded state and the at least one condition having a normal state into a diagnostic model, wherein the diagnostic model represents a data structure defining causal relationships between nodes, wherein the data structure includes a plurality of the nodes representing components of the system, and wherein each of the nodes includes a plurality of states. Additionally, the method may comprise isolating, using the diagnosis model, a failed or degraded component of the system, and providing a maintenance action for the failed or degraded component.

In still another aspect, a non-transitory computer-readable medium storing instructions is disclosed that, when the instructions are executed by one or more processors, causes the one or more processors to perform operations. The operations may include receiving operational data associated with the system, wherein the operational data includes a plurality of sensor measurements for each sensor of a plurality of sensors of the system, and wherein the sensor measurements are indicative of conditions or states of the system. The operations may also include comparing the plurality of sensor measurements from each sensor to a respective threshold value, determining, based on the comparisons, a condition of the system having a degraded state and one or more conditions of the system having a normal state, and selecting, by the one or more processors, at least one of the one or more conditions of the system having a normal state. Further, the operations may include inputting the condition having degraded state and the at least one condition having a normal state into a diagnostic model, wherein the diagnostic model represents a data structure defining causal relationships between nodes, wherein the data structure includes a plurality of the nodes representing components of the system, and wherein each of the nodes includes a plurality of states. Additionally, the operations may include isolating, using the diagnosis model, a failed or degraded component of the system, and providing a maintenance action for the failed or degraded component.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE DRAWINGS

A more complete understanding of embodiments of the present application may be derived by referring to the detailed description and claims when considered in conjunction with the following figures, wherein like reference numbers refer to similar elements throughout the figures. The figures are provided to facilitate understanding of the disclosure without limiting the breadth, scope, scale, or applicability of the disclosure. The drawings are not necessarily made to scale.

FIG. 1 illustrates a block diagram of a vehicle, according to an example embodiment;

FIG. 2 is a block diagram for constructing a diagnosis model, according to an exemplary embodiment;

FIG. 3 is a block diagram of a method for detecting anomalies of a system and for identifying a failed or degraded component of the system, according to an exemplary embodiment;

FIGS. 4A and 4B show graphs of selected sets of discretized sensor data taken over 40 flights, according to an exemplary embodiment;

FIGS. 5-6 shows graphs of temperature measurements generated by sensors of a system, according to an exemplary embodiment;

FIG. 7 illustrates a block diagram of a fault diagnosis system for an aircraft, according to an exemplary embodiment; and

FIG. 8 illustrate a partial diagnosis model of a system, according to an exemplary embodiment.

### DETAILED DESCRIPTION

The following detailed description describes various features and functions of the illustrative systems, methods, and apparatus with reference to the accompanying figures. The following detailed description is exemplary in nature and is not intended to limit the disclosure or the application and uses of the embodiments of the disclosure. Descriptions of specific devices, techniques, and applications are provided only as examples. It may be readily understood that certain aspects of the illustrative systems, methods, and apparatus can be arranged and combined in a wide variety of different configurations, all of which are contemplated herein. Thus, other embodiments can be utilized and other changes can be made without departing from the scope of the subject matter presented herein.

The present application provides embodiments of systems, methods, and apparatus for fault diagnosis or isolation of complex systems, such as aircraft systems. The embodiments include techniques for detecting anomalies or adverse conditions of a system and for reliably identifying and/or isolating a failure or degradation of one or more components (e.g., line replacement units (LRU) or lower level internal components within an LRU) that caused the anomalies or adverse conditions of the system. The embodiments may be configured to receive operational data, such as sensor signals or measurements generated from sensors of a system, for detecting anomalies or adverse conditions of the system. For example, the embodiments may be configured to receive and analyze sensor signals or measurements to determine conditions of the system that are within predetermined operational ranges or limits (e.g., a normal state) or outside of the predetermined operational ranges or limits (e.g., a failed or degraded state).

The conditions of the system may be selected and inputted into a diagnosis model, such as a Bayesian network. Each of the conditions of the system may be associated with a normal state or a degraded/failed state. The embodiments may be configured to implement the diagnosis model to identify and/or isolate a failure or degradation of a component (e.g., a faulty LRU or a lower level component within an LRU) based on the states of the conditions of the system. As such, the embodiments may improve troubleshooting processes of systems in order to decrease the time required to identify and/or isolate a failed or degraded component of the systems.

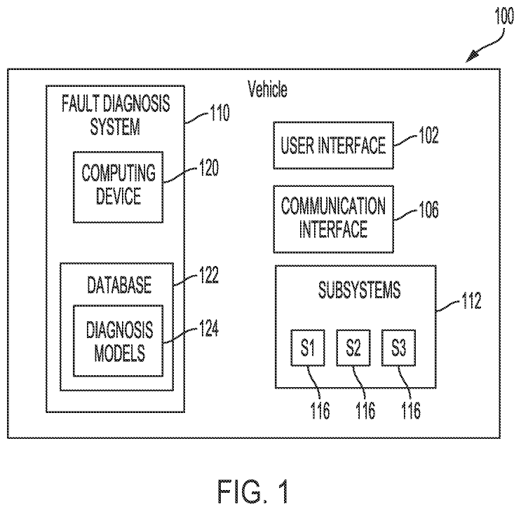

Referring more particularly to the drawings, FIG. 1 illustrates a block diagram of a vehicle 100 or machine, according to an exemplary embodiments. The vehicle 100 may be an aircraft, such as a commercial or military jet. Alternatively, the vehicle 100 may be a land-based vehicle, a boat or water-based vehicle, an aerospace vehicle, or any other suitable vehicle. As shown in FIG. 1, the vehicle 100 includes a user interface 102, a communication interface 106, a fault diagnosis system 110 or fault isolation system, and one or more subsystems 112 located throughout, on, or within the vehicle 100.

The subsystems 112 of the vehicle 100 may be operatively connected to the fault diagnosis system 110. The subsystems 112 may control, perform, and/or monitor one or more aspects of the operation of the vehicle 100. Each of the subsystems 112 may be an electronic, mechanical, and/or hardware sub-system. For example, if the vehicle 100 is an aircraft, the subsystems 112 may include an air trim system, an environmental control system, a propulsion system, a flight control system, an electrical system, a hydraulic system, a pneumatic system, a communication system, a guidance system, a navigation system, a radar system, a pneumatic system, an air-conditioning system, a blower, an air intake system and/or any other aircraft system. If the vehicle 100 is an automobile, for example, the subsystems 112 may include a fuel-monitoring system, a tire pressure monitoring system, an oil monitoring system, an air conditioning system, an engine control system, and/or any other automotive system. As such, the subsystems 112 may include any system, hardware, equipment, or the like of the vehicle or machine that can be monitored or analyzed to determine the condition or state of the subsystem and/or whether the subsystem is properly functioning.

The subsystems 112 of the vehicle 100 may be a portion of other systems or subsystems of the vehicle 100. For example, a subsystem may be a trim air system which may be a subsystem of an environmental control system. Each of the subsystems 112 may include one or more components (not shown) for performing one or more functions of the subsystem 112. The components may be electrical, optical, mechanical, hydraulic, fluidic, pneumatic, or other types of components. For example, the components may be electro-mechanical components such as a motor, an actuator, a valve, a pump, an actuator, a battery, a servomechanism, an engine, an electronic module, and an airframe member. The components may be referred to as parts, elements, modules, units, etc., and may be line replaceable units and/or field replaceable units. The components may be subsystems of a respective subsystem. The components may be active and/or controlled components (i.e., components configured to change state during operation).

The subsystems 112 of the vehicle 100 may include one or more sensors 116 operably connected with the fault diagnosis system 110. The sensors 116 may be configured to measure and/or monitor the performance of individual components, groups of components, and/or the subsystems 112. For example, the sensors 116 may be configured to sense or monitor operational or performance data (e.g., operational parameters or variables, sensor measurements, etc.) of the subsystems 112. The operational or performance data may include any attribute, condition, feature, behavior, or the like that may change over time, such as voltage, current, fluid pressure (e.g., air pressure), temperature, and the like. As shown, the subsystems 112 may include three sensors 116, but each subsystem 112 may include any number of sensors. Additionally or alternatively, the sensors 116 may measure and/or monitor the environmental conditions and/or the inputs/outputs of the subsystems 112. The sensors 116 may also be utilized in built-in testing, performance monitoring, and/or subsystem control.

The user interface 102 of the vehicle 100 may allow an operator or mechanic to interact with the fault diagnosis system 110. The user interface 102 may represent any device that enables the fault diagnosis system 110 to receive input from the operator and/or to provide output to the operator. For example, to receive input from the operator, the user interface 102 may include keyboards or keypads, mouse devices, touch screens, microphones, speech recognition packages, or the like. For example, the operator may use the user interface 102 of the vehicle 100 to access the fault diagnosis system 110 to determine components that caused a failure or a degradation of a subsystem. To provide output to the operator, the user interface 102 may include a display that is configured to present visual, audio, and/or tactile signals to the operator and/or user of the fault diagnosis system 110. For example, the user interface 102 may be configured to display characteristics of the subsystem of the vehicle 100 and indicate a failed or degraded component of the subsystem along with an image representative of the component. In other embodiments, the user interface 102 may include speakers, printing mechanisms, or the like. Further, the user interface 102 may provide maintenance actions for the operator, such as scheduling a repair of a component of the vehicle.

The communication interface 106 may enable information to be received from a remote system and/or to be send information to the remote system. For example, the communication interface 106 may enable the fault diagnosis system 110 or a system of the vehicle 100 to communicate, via a wireless channel or a wired communication link, with remote computer systems, such monitoring or maintenance systems located remotely from the vehicle 100 (e.g. a health monitoring or diagnostic system). The communication interface 106 may enable communications via any number of wireless broadband communication standards, such as the Institute of Electrical and Electronics Engineering (IEEE) standards 802.11, 802.12, 802.16 (WiMAX), 802.20, cellular telephone standards, or other communication standards.

As shown in FIG. 1, the fault diagnosis system 110 of the vehicle 100 includes a computing device 120 and a database 122. The fault diagnosis system 110 may be in communication with the subsystems 112 or systems of the vehicle 100. For example, the fault diagnosis system 110 may be in communication with the sensors 116 of the subsystems 112 through wired and/or wireless connections or links. The fault diagnosis system 110 may also be configured to communicate with a remote computer system (e.g., a remote monitoring or diagnostics system) via the communication interface 106. The fault diagnosis system 110 may assist mechanics in diagnosing and troubleshooting anomalies and/or adverse conditions of the system. For example, the fault diagnosis system 110 may be configured to identify and/or isolate a failure or degradation of a component of the subsystem, such as a failed LRU or a lower level component within an LRU. When the fault diagnosis system 110 identifies and/or isolates a faulty or degraded component, the fault diagnosis system 110 may provide a maintenance action, such as scheduling maintenance for the vehicle 100, notifying a mechanic, an operator, or the like.

The fault diagnosis system 110 of the vehicle 100 may be configured to store operational or historical data relating the subsystems 112 of the vehicle 100. For example, the fault diagnosis system 110 may be configured to receive operational or historical data (e.g., parameters or variables) associated with the subsystems 112 of the vehicle 100. The operational data may include sensor signals or measurements (e.g., in-service or raw data) from the sensors of the subsystems 112 of the vehicle 100. The operational data may be indicative or representative of the states or conditions of the subsystems 112 of the vehicle 100. For example, the operational data may include any attribute, condition, feature, behavior, characteristic, or the like that may change over time, such as voltage, current, fluid pressure (e.g., air pressure), temperature, and the like. When the vehicle 100 is an aircraft, the operational data may include flight data, which may be collected over multiple flights.

The fault diagnosis system 110 of the vehicle 100 may analyze the operational data to identify anomalies or adverse conditions of the subsystems 112 of the vehicle 100 (e.g., sensor signals or measurements outside normal ranges or thresholds). For example, the fault diagnosis system 110 may analyze the sensor signals or measurements from the sensors of the subsystems 112 to determine whether one or more of the conditions associated with the subsystems 112 are normal or degraded/failed. When one or more of the conditions of a subsystem are degraded, the fault diagnosis system 110 may select at least one of the one or more of conditions of the subsystem that are degraded and at least one of the one or more of the conditions of the subsystem that are normal as inputs (e.g., evidences) into a diagnosis model of the subsystem.

The diagnosis model of the subsystem may correlate or model the causal relationships between the states of the conditions of the subsystem and component failures as further described below. The fault diagnosis system 110 may implement the diagnosis model based on the states of the selected conditions of the subsystem (e.g., normal and failed/degraded) to efficiently and quickly identify one or more failed or degraded components causing the anomaly or adverse condition of the subsystem of the vehicle 100. For example, the diagnosis model may be executed to identify a failed or degraded component of the subsystem based on the states of the conditions of the subsystems. Each condition may have a normal or degraded/failed state.

As shown in FIG. 1, the fault diagnosis system 110 may be located within the vehicle 100. For example, the fault diagnosis system 110 may be a part of the vehicle 100 (an on-board system, also referred to as an on-platform system). Alternatively, the fault diagnosis system 110 may be remotely located from the vehicle 100 (e.g., an off-board system). For example, the fault diagnosis system 110 may be located at a central or fixed land-based location or site. When the fault diagnosis system 110 is remotely located from the vehicle 100, the fault diagnosis system 110 may receive operational data (e.g., sensor measurements or signal) from a plurality of vehicles (e.g., a fleet of vehicles) for detecting anomalies or adverse conditions of the subsystems of the vehicles and for diagnosing failed or degraded components based on the states of selected conditions of the subsystems of the vehicles. In other embodiments, the fault diagnosis system 110 may be portable allowing a mechanic to carry the fault diagnosis system 110 to the vehicle 100. For example, the fault diagnosis system 110 system may be a mobile, handheld, or laptop computer or any other suitable computer-based device. Further, the fault diagnosis system 110 may be implemented in the cloud. For example, the fault diagnosis system may include components in a cloud architecture that may be accessed by a client or user computer over the Internet.

The database 122 of the fault diagnosis system 110 may store the diagnosis models 124 for isolating degraded or failed components of the subsystems or systems of the vehicle 100. The diagnosis models 124 may correlate the causal relationships between degraded/failed components and anomalies or adverse conditions of the subsystem and include the probabilities of the respective causal relationships. The diagnosis models 124 may include or represent a plurality of nodes interconnected in a manner defined by system or architecture information (e.g., designs, specifications, schematics, etc.) of the subsystems of the vehicle 100. For example, a diagnosis model may include nodes representing the components of a subsystem. Each node may have at least two states and a probability may be assigned to each state of a node. The diagnosis models 124 of the subsystems may be developed or generated during the design, testing, manufacturing, or operational phase of the subsystems of the vehicle 100. For example, the diagnosis models 124 may be generated by the computing device 120 of the fault diagnosis system 110 as further described below.

In some embodiments, the diagnosis models 124 may include graphical probabilities models, such as Bayesian networks. In other embodiments, the diagnosis models 124 may be constructed utilizing model-based or case-based reasoning, directed acyclic graphs, neural networks, fuzzy logic, expert systems or the like. When the vehicle 100 is an aircraft, the diagnosis models 124 may model or represent an airframe, a hydraulic system, an environmental system, a flight management system, a navigation system, a communications system, a sensor system, or some other system, subsystem, or component of the aircraft. For example, a diagnosis model may model an air trim system of an aircraft as further described below.

The database 122 of the fault diagnosis system 110 may also store operational data associated with subsystems of the vehicle 100. The operational data may include sensor data (e.g., parameters and/or variables) generated by one or more sensors associated with the subsystems 112 of the vehicle 100. For example, the operational data may include sensor signals or measurements (e.g. temperatures, positions, pressures, altitude, speed, operating state, electrical currents, and actuator positions, etc.) associated with the subsystems of the vehicle 100. The sensor signal or measurements may be indicative of the one or more states or conditions of the subsystems. For aircraft, the operational data may be acquired or recorded for each flight of the aircraft. The operational data received from the sensors of the subsystems may be pre-processed or discretized. For example, the operational data may include discrete samples of sensor signals or measurements in a time series covering a period of observation. In some embodiments, the operational data may be associated with a timestamp indicative of a time at which the sensor data was received. The timestamp can have a resolution of minutes, seconds, milliseconds, etc.

The database 122 of the fault diagnosis system 110 may also store information relating to the design of the subsystems 112 or systems of the vehicle. For example, the database 122 may include system information (e.g., schematics, specifications, designs, etc.) about the architecture or structure of the subsystems 112 of the vehicle 100. Further, the database 122 may include fault tree information defining relationships between failures and degradations of components that may be based on fault isolation manuals (FIMs), fault reporting manuals (FRMs) and airplane maintenance manuals (AMMs). Additionally, the database 122 may include failure modes effects and criticality analysis (FMECA) information (e.g., probability of failure (POF), reference and statistical data (e.g., fault tolerance levels, operational sensor ranges and limits, sensor thresholds, expected parameters, etc.), maintenance data (e.g. maintenance actions and messages, engine indicating and crew alerting system (EICAS) information, component installations and removals, etc.), component reliability, and probabilistic information. The probabilistic information may include relative probabilities of the various causal relationships of the components of the subsystems and the probability of a failure or degradation state or condition of each component of the subsystem. The probabilistic information (e.g., probability of occurrence) may be generated using historical knowledge, machine learning techniques, failure modes effects and criticality analysis (FMECA) information, probability of failure (POF) information, or a combination thereof the one or more conditional probabilities are defined using conditional probability tables

The database 122 of the fault diagnosis system 110 may comprise volatile and non-volatile memory or removable and non-removable memory implemented in any method or technology for storage of information, such as computer-readable instructions, data structures, program modules or other data. The memory may include, but is not limited to, RAM, ROM, EPROM, EEPROM, or other solid state memory technology, CD-ROM, DVD, or other optical storage, magnetic cassettes, magnetic tape, magnetic disk storage or other magnetic storage devices, or any other medium which may be used to store desired information (e.g., system information, operational data, etc.) and that may be accessed by the computing device 120 of the fault diagnosis system 110.

Referring still to FIG. 1, the computing device 120 of the fault diagnosis system 110 may generate or receive the diagnosis models 124 of the subsystems 112 of the vehicle 100. For example, the computing device 120 may be configured to construct or build the diagnosis models 124 of the subsystems 112 of the vehicle 100. The diagnosis models 124 may be constructed or generated during the design, testing, manufacturing, or operational phase of the subsystem. The construction of the diagnosis models 124 may be automated in order to increase the efficiency with which the diagnosis models 124 are constructed and to reduce inconsistency. The computing device 120 may be configured to implement or execute the diagnosis models 124 to identify or isolate a failure or degradation of one or more components of the subsystems 112 that caused an anomaly or adverse condition of the subsystems 112 of the vehicle 100 as further described below. As such, the computing device 120 may use the diagnosis models 124 to quickly and efficiently identify and/or isolated degraded or failed components of the subsystems 112 of the vehicle 100.

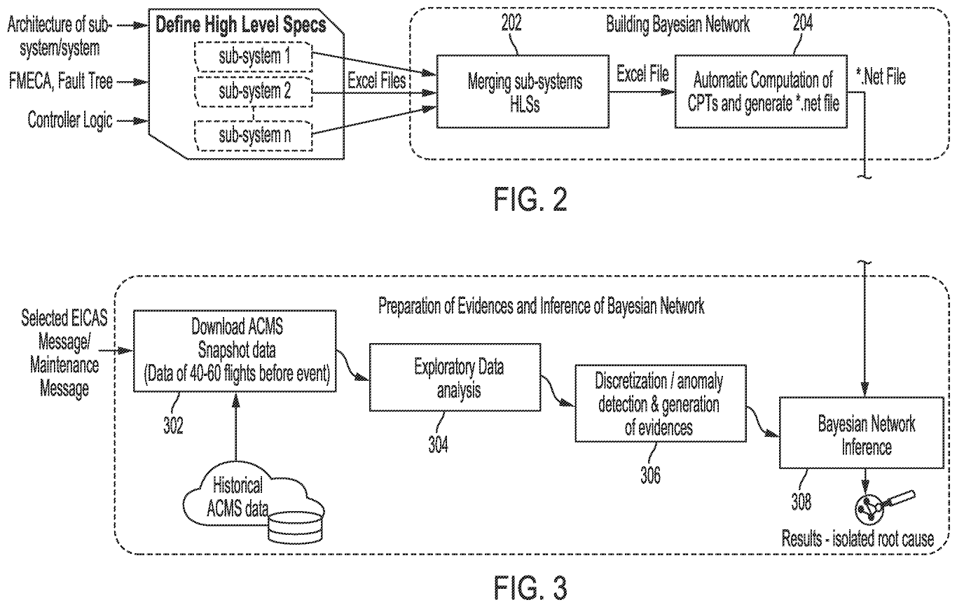

Referring now to FIG. 2, a block diagram of a method of constructing of diagnostic models is illustrated, according to an exemplary embodiment. A processing unit or computing device may construct the diagnosis models. For example, the computing device 120 of the fault diagnosis system 110 may receive and process information stored in the database 122 of the fault diagnosis system 110 to construct the diagnosis models 124. In some examples, the computing device 120 may be configured to interface or communicate with external databases to retrieve the information for constructing or building the diagnosis models 124. At block 202, the computing device 120 of the fault diagnosis system 110 may receive information to define the hierarchy or high level specification (e.g., the architecture of one or more subsystem or systems, fault tree information, and FMECA information (e.g., probability of failure (POF)) of the subsystems 112 or systems of the vehicle 100 and merge the information to construct the diagnosis models 124 of the subsystems 112 of the vehicle 100. The computing device 120 may also receive controller logic or instructions to enable the computing device 120 to construct the diagnosis models 124 of the subsystems 112 of the vehicle 100.

At block 204, the computing device 120 of the fault diagnosis system 110 may construct the diagnosis models 124 by creating a plurality of nodes to represent the components and the states or conditions of the subsystems or systems based the system information (e.g., system architecture), FMECA information (e.g., probability of failure (POF), and fault tree information of the subsystems of the vehicle 100. The computing device 120 may construct the diagnosis models 124 to correlate the causal relationships between the failures or degradation of the components and anomalies or adverse conditions of the subsystems and include the probabilities associated with the respective causal relationships. For example, the computing device 120 may create nodes with collectively exhaustive, mutually exclusive discrete states, and connect or correlate the nodes in instances in which a relationship exists between the nodes, such as in instances in which the state of a first node effects the state of a second node. The computing device 120 may also generate nodes that represent functional parameters or quantities that describe the subsystems and may correspond the causes (component nodes) to the effects in the diagnosis models. The nodes representing a component may have at least two (mutually exclusive and collectively exhaustive) states (e.g., normal or failed/degraded). The computing device 120 may assign a probability to each state of a node based upon estimates that may be derived from component reliability data. For example, each node of a component may be associated with a conditional probability table (CPT). The table may hold the conditional probabilities relating the states of its parent nodes to the probability of its own states. In some embodiments, the conditional probability tables may define the causal relationship from a parent node to a child node by determining a probability of occurrence for a respective transition from each state of the parent node to each state of the child node.

The computing device 120 may construct the diagnosis models 124 utilizing Bayesian networks. The Bayesian networks may be modular, which allows the network to grow and improve over time by inserting additional nodes. The performance of the Bayesian networks may also be improved by means of learning from historical data stored in the database 122 of the fault diagnosis system 110. In other embodiments, the diagnosis models 124 can be constructed utilizing model-based or case-based reasoning, neural networks, fuzzy logic, expert systems or the like. Once constructed, the Bayesian networks may be implemented to identify or isolate one or more degraded or failed components that caused an anomaly or adverse condition of a subsystem of the vehicle 100, such as one or more LRUs or lower level components within an LRU.

The computing device 120 of the fault diagnosis system 110 may comprise one or more computers, control units, circuits, or the like, such as processing devices, that may include one or more microprocessors, microcontrollers, integrated circuits, and the like. The computing device 120 may also include memory, such as non-volatile memory, random access memory, and/or the like. The memory may include any suitable computer-readable media used for data storage. The computer-readable media may be configured to store information that may be interpreted or analyzed by the computing device 120. The information may be data or may take the form of computer-executable instructions, such as software applications, that cause a microprocessor or other such control unit within the computing device 120 to perform certain functions and/or computer-implemented methods.

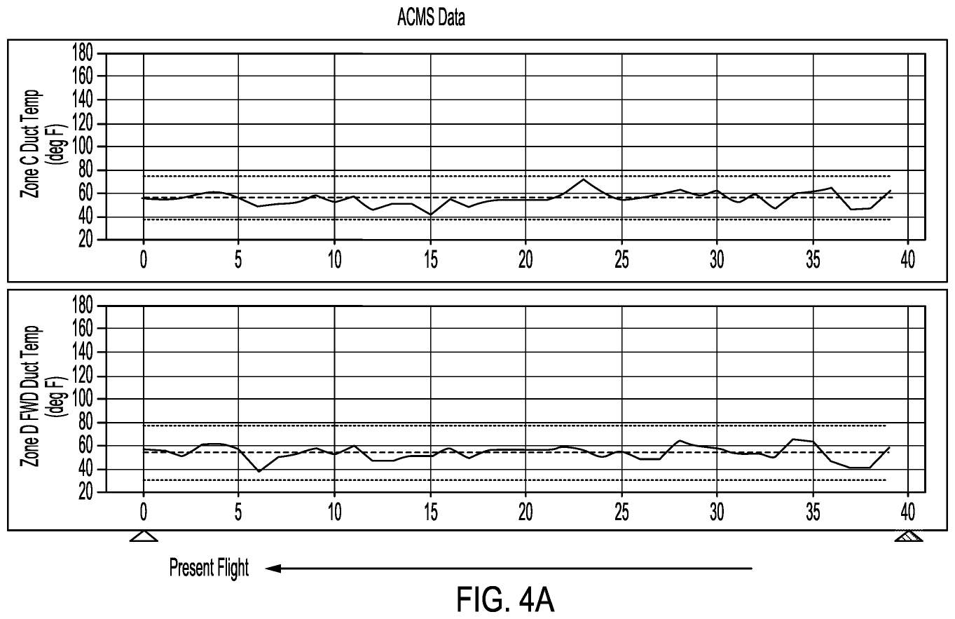

FIG. 3 illustrates a method 300 for detecting anomalies or adverse conditions of a subsystem of the vehicle 100 and for identifying or isolating a failed or degrade component of the subsystem, according to an example embodiment. The method 300 may be implemented by a processing unit or computing device, such as the computing device 120 of the fault diagnosis system 110. At block 302, the computing device 120 may download or receive maintenance information (e.g., EICAS messages) and/or operational data associated with one or more sensors of a subsystem of the vehicle 100 (e.g., sensor data, signals, and/or measurements, etc.). For example, the computing device 120 may access and retrieve operational data and maintenance data from the database 122 of the fault diagnosis system 110. The operational data may be indicative of one or more conditions or states of a subsystem of the vehicle 100. In one embodiment, the operational data may include a snapshot of sensor data or measurements from a number of missions or operations over a period of time. For example, for an aircraft, the operational data may include aircraft condition monitoring systems (ACMS) data or information from 40-60 flights. The ACMS data may include sensor measurements from one or more sensors (or detectors) indicative of one or more conditions or states of the subsystem of an aircraft.

At block 304, an exploratory data analysis may be performed. After receiving the operational data (e.g., sensor measurements) from the sensors, the computing device, such as the computing device 120, may perform an exploratory data analyses of the maintenance information and/or operational data received from the sensors 116 of the subsystems 112. For example, the computing device 120 may perform univariate analysis, bivariate analysis, outlier detection, correlation analysis and the like. The computing device 120 may also pre-process and/or prepare the operational data for further analysis and data processing. For example, pre-processing algorithms may be applied to the operational data to organize, format, filter, reduce dimensionality, separate measurements, eliminate missing or inaccurate data, and/or any other appropriate modifications. When the operational data includes sensor signals or measurements from multiple sources, the computing device 120 may pre-process the operational data which may include merging data, harmonizing formatting, and matching architecture structures.

At block 306, the operational data (e.g., sensor signals or measurements) may be discretized and the operational data may be analyzed for anomalies or adverse conditions. For example, the computing device, such as the computing device 120 of the fault diagnosis system 110, may discretize continuous variables of the operational data and may determine or detect anomalies or adverse conditions of a subsystem of the vehicle 100 based on the operation data. The computing device 120 may compare the operational data associated with each sensor to one or more threshold values to determine anomalies or adverse conditions of the subsystem of the vehicle 100. In some embodiments, the threshold values may be dynamically computed. For example, the computing device 120 may dynamically compute the threshold values for the sensor measurements based on the root mean square and/or the standard deviation of the sensor data or measurements over a time period, such as 30% of the sensor measurements received for the previous 40-60 flight legs. If the operational data associated with a sensor exceeds or is equal to a predetermined upper threshold value and/or is below or equal to a predetermined lower threshold value, the computing device 120 may determine that a condition of the subsystem is degraded or failed. In some embodiments, the sensor signals or measurements of the sensor may be compared to a single predetermined threshold value. Thus, the computing device 120 may determine whether the sensor signals or measurements of the sensors of the subsystem are within normal operating ranges or limits or exceeds a threshold value. For example, the computing device 120 may determine that the state or condition of the subsystem is normal when the sensor measurements are within predetermined threshold values. Similarly, the computing device may determine the state or conditions of the subsystem is degraded or faulty when the sensor measurement are outside of the predetermined threshold values.

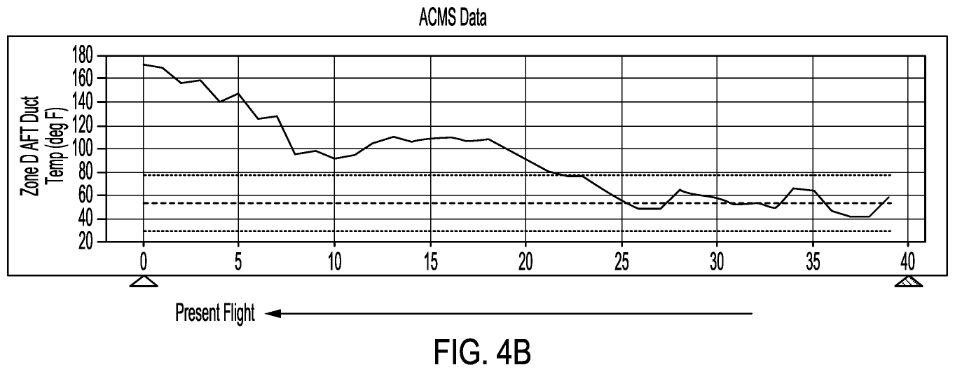

As shown in FIG. 4, graphs are shown of selected sets of discretized sensor data taken over 40 flights. The sensor data may include temperature measurements associated with sensors (e.g., temperature sensors) at three different duct locations. Based on the temperature measurements shown in FIG. 4, the computing device 120 of the fault diagnosis system 110 may determine that the temperature measurements for Zone D FWD duct and Zone C duct are within normal temperature ranges as indicated by the upper and lower dashed lines (e.g., the sensor measurements are within the threshold values). The computing device 120 may also determine that the temperature measurements of Zone D Aft duct for flights 23-40 are within the normal temperature range, however, the computing device 120 may determine that the temperature measurements for flights 21 through the present flight exceed a threshold limit or value. Upon detecting a temperature measurement that is outside of the normal temperature range or exceeds a threshold value, the computing device 120 may implement a diagnosis model based on the states or conditions of the subsystem to determine a failed or degraded component that caused the temperature measurement to exceed the threshold value as further described below.

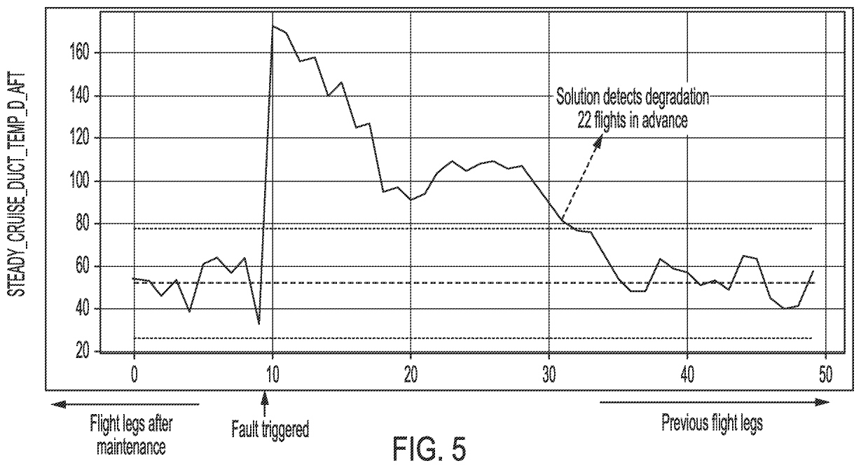

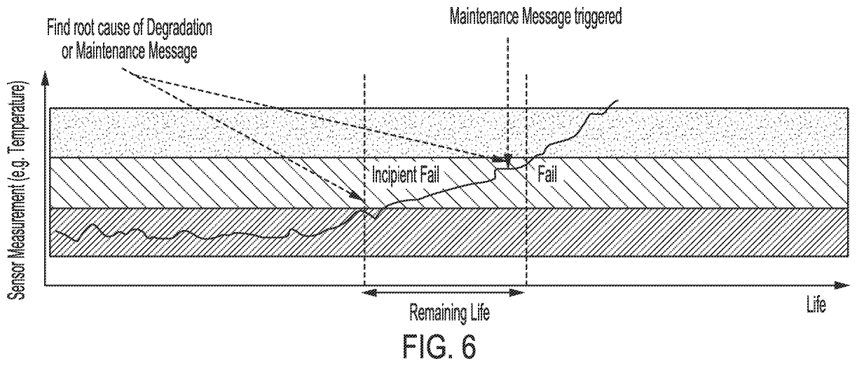

Further, the computing device 120 of the fault diagnosis system 110 may generate a maintenance message when the sensor measurements exceeds the normal operating ranges or limits by a second threshold value. The maintenance messages may be used as evidences of inferences for input into the diagnosis model as further described below. For example, FIGS. 5 and 6 show additional graphs of the discretized sensor data for D AFT duct with a maintenance message being triggered. As shown in FIG. 5, based on the sensor data, the computing device 120 may determine that the temperature measurements from the sensor associated with the D Aft duct are within a normal temperature range (between the upper and lower dashed lines) for flights 33-50. At flight 32, the computing device 120 may detect an anomaly or adverse condition of the D AFT duct based on the sensor measurements. For example, the computing device 120 may determine that the temperature measurement of the D Aft duct exceeds the upper threshold of the normal operating range or limit indicating a degraded or failed condition or state of the subsystem. When computing device 120 determines that the temperate measurement of the D Aft duct exceeds the upper threshold, the computing device 120 may implement a diagnosis model of the subsystem to determine a failed or degraded component based on at least the degraded/failed condition and one or more selected conditions of the subsystem. The computing device 120 may identify and isolate a failed component at the thirty-second (32^{nd}) flight so that the failed component may be repaired or replaced. As a result, the computing device may identify or isolated a failed or degrade component at twenty-two (22) flights prior to when a maintenance message would be generated as showing in FIG. 5. Further, when the maintenance message is generated, the computing device 120 may implement the diagnosis model based on the maintenance message. For example, the computing device 120 may determine states, conditions, and/or parameters of the subsystem and input this information into the diagnosis model to identify and/or isolate a degraded or failed component of the subsystem.

Referring again to FIG. 3, the computing device 120 may implement the diagnosis model, such as a Bayesian network, at block 308. The computing device 120 may implement or execute the Bayesian network to identify a failure or degradation of one or more components, such as LRUs or lower level components within an LRU, that caused an anomaly or adverse condition of the subsystem of the vehicle 100. The computing device 120 may select one or more conditions of the system to input (e.g., evidences of inferences) into the Bayesian network. For example, the computing device 120 may select and input, into the Bayesian network, one or more conditions of the system having degraded/failed state and one or more conditions of the system having a normal state.

The Bayesian network may include a plurality of nodes interconnected in a manner defined by the system architecture of the subsystem or system as described above. The Bayesian network may represent the causal relationships between failed or degraded components and conditions of the subsystem and include the probabilities of the respective causal relationships. Each node may have at least two states and a probability for each state of a node. Based on the states of the nodes, the computing device 120 of the fault diagnosis system 110 may determine a degraded or failed component that caused an anomaly or adverse condition of the subsystem. Accordingly, the computing device 120 may implement the Bayesian network based on the state or conditions of the subsystems (e.g., normal or degraded) to identify one or more components, such as LRUs or lower level components within an LRU, that caused an anomaly or adverse condition of the subsystem.

When a failed or degraded component is identified, the computing device 120 of the fault diagnosis system 110 may generate and send one or more alerts. The alerts may be sent to technicians or maintenance personnel to notify of a failed or degraded component of a subsystem or system. For example, the alerts may identify the component of the subsystem of the vehicle 100 that failed and should be replaced. The computing device 120 may present the degraded or failed component upon a display or a prioritized listing based upon the failure or degradation of the component of the subsystem. As such, the technicians or maintenance personnel may efficiently and quickly repair, update or replace the one or more components related to or causing the anomaly or adverse condition of the subsystem of the vehicle 100.

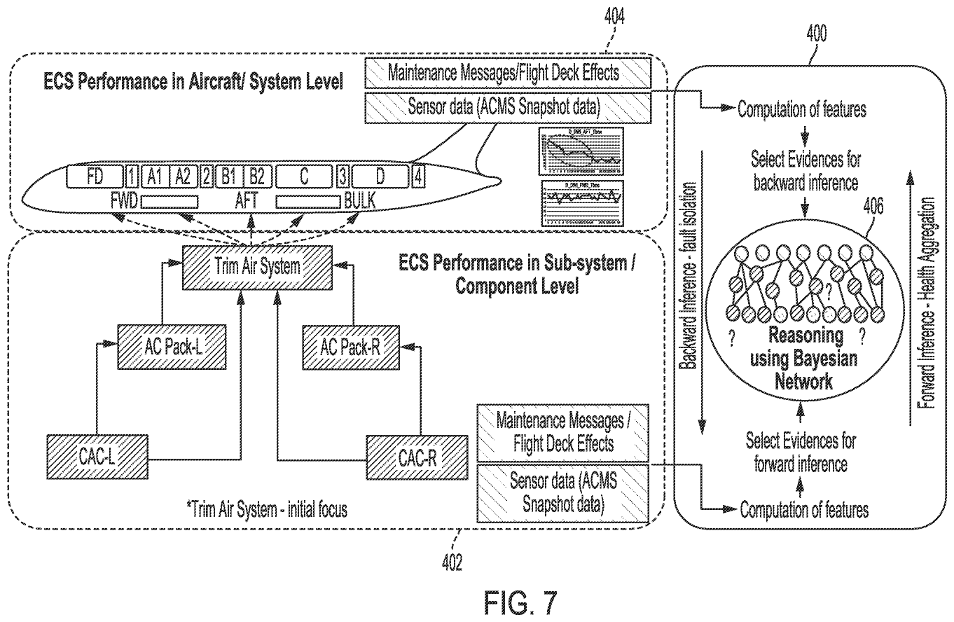

Referring now to FIG. 7, a fault diagnosis system 400 for an air trim system 402 of aircraft 404 is shown. The fault diagnosis system 400 may detect anomalies or adverse conditions of the air trim system 402 based on sensor measurements. Further, the fault diagnosis system 400 may identify and isolate a degraded or failed component of the air trim system 402 of the aircraft 404 that caused the anomaly or adverse condition. For example, the fault diagnosis system 400 may implement a Bayesian network of the air trim system 402 of the aircraft 404 to identify and/or isolate one or more failed or degraded components, such as LRUs or lower level components within an LRU, that caused the anomaly or adverse conditions.

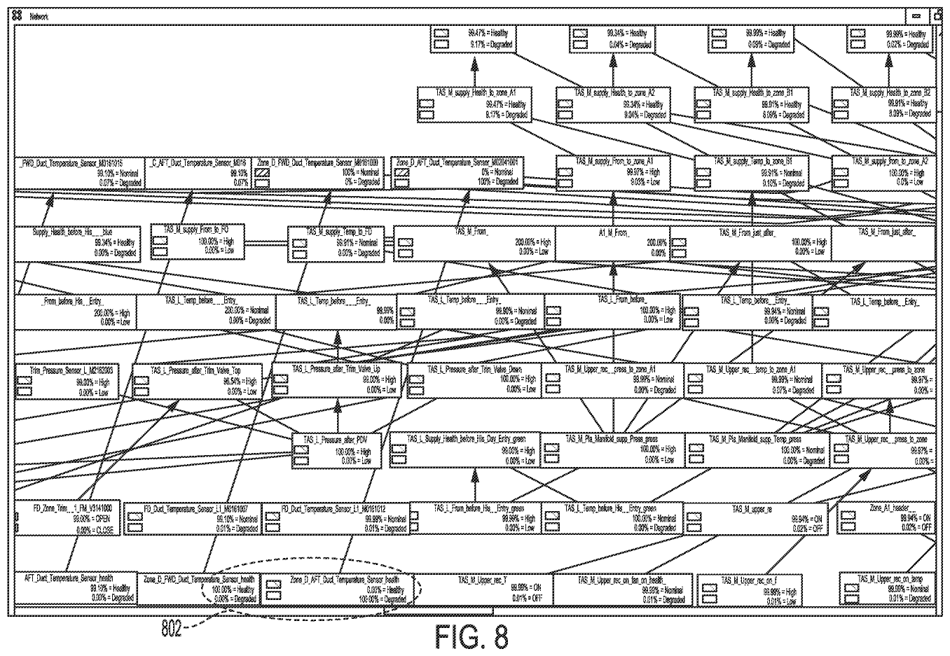

The Bayesian network may be constructed based upon systemic information of the air trim system 402 and may include nodes for the components of the air trim system 402, including AC packs and the cabin air controls/pressure. FIG. 8 shows a partial Bayesian network of the air trim system 402 having nine node layers. Although the Bayesian network is illustrated as including nine layers, it will be appreciated that in other embodiments having fewer or more than nine layers may be used to create a particular diagnosis model of the air trim system 402.

The fault diagnosis system 400 may implement the Bayesian network by inputting the conditions of the subsystem, maintenance messages, flight effects, or a combination thereof into the Bayesian network. For example, the conditions inputted into the Bayesian network may include one or more conditions of the system having a degraded/failed state and one or more conditions of the system having a normal state. The maintenance messages input into the Bayesian network may be messages or codes that are generated by the air trim system 402 which may identify any maintenance items or items warranting attention. When the fault diagnosis system 110 implements the Bayesian network based on the inputs, the fault diagnosis system 400 may be configured to identify and/or isolate one or more degraded or failed components. As shown in FIG. 8, a temperature sensor 804 may be identified as a failed or degraded component based on the input of the state or conditions of the subsystem of the aircraft 404.

When the fault diagnosis system 400 identifies a failed or degraded component, the fault diagnosis system 400 may generate alerts. Based on the generated alerts, a maintenance action such as inspection, testing, repair, or replacement of equipment, may be taken by maintenance workers to avoid potential costly and disruptive unplanned component replacements or other undesirable maintenance events. Further, the fault diagnosis system 400 can present the failed or degraded component upon a display or a prioritized listing. Although the fault diagnostic system has been described and illustrated in conjunction with the troubleshooting of an aircraft, the fault diagnosis system 400 can be used to troubleshoot any system having a number of interconnected components, such as the complex systems created by the automotive, marine, electronics, power generation and computer industries. As such, the foregoing description of the utilization of the fault diagnosis system 400 and method in the aircraft industry was for purposes of illustration and example and not of limitation since the fault diagnosis or isolation procedure described above is equally applicable in many different industries.

By utilizing the fault diagnosis systems of the present application, a mechanic can efficiently troubleshoot a complex interconnected subsystems or system of a vehicle or machine. In this regard, the diagnostic models incorporated within the fault diagnostic systems include systemic information such that the resulting diagnosis is reliable, thereby reducing the number of components that are replaced that are actually functioning properly and reducing the instances in which the troubleshooting process must be delayed in order to contact a representative of the aircraft manufacturer for assistance. By automating the relatively complex diagnosis procedures, the time required to troubleshoot a problem is substantially diminished, thereby permitting a decision to be made regarding repair of a failed or degraded components of the subsystems or systems. As a result, the fault diagnostic systems disclosed herein should reduce the number of flights that are delayed or cancelled for unscheduled maintenance.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

While the embodiments have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed embodiments include all embodiments falling within the scope of the appended claims.

The embodiments described herein can be realized in hardware, software, or a combination of hardware and software. For example, the embodiments can be realized in a centralized fashion in at least one computer system or in a distributed fashion where different elements are spread across interconnected computer systems. Any kind of computer system or other apparatus adapted for carrying out the methods described herein can be employed. Further, the embodiments described herein can be embedded in a computer program product, which includes all the features enabling the implementation of the operations described herein and which, when loaded in a computer system, can carry out these operations.

1. An apparatus for diagnosing faults of a system comprising:
a memory; and
a processor in communication with the memory, wherein the processor is configured to:
receive operational data associated with the system, wherein the operational data includes a plurality of sensor measurements for each sensor of a plurality of sensors of the system, and wherein the sensor measurements are indicative of conditions or states of the system;
compare the plurality of sensor measurements from each sensor to a respective threshold value;
determine, based on the comparisons, a condition of the system having a degraded state and one or more conditions of the system having a normal state;
select at least one of the one or more conditions of the system having a normal state;
input the condition having degraded state and the at least one condition having a normal state into a diagnostic model, wherein the diagnostic model represents a data structure defining causal relationships between nodes, wherein the data structure includes a plurality of the nodes representing components of the system, and wherein each of the nodes includes a plurality of states;
isolate, using the diagnosis model, a failed or degraded component of the system; and
provide a maintenance action for the failed or degraded component.

2. The system according to claim 1, wherein the processor is further configured to:
receive maintenance information relating to the system;
determine a maintenance condition based on the maintenance information;
input the maintenance condition into the diagnostic model; and
isolate, using the diagnosis model, one or more failed or degraded components of the system.

3. The system according to claim 2, wherein the operational data includes historical operational data of the system, wherein the maintenance information includes a failure message or event, and wherein the maintenance action identifies the failed or degraded component of the system.

4. The system according to claim 1, wherein the diagnostic model includes a Bayesian network.

5. The system according to claim 1, wherein the data structure of the diagnosis model comprises a directed acyclic graph representing the causal relationships between at least some of the nodes.

6. The system according to claim 1, wherein the plurality of states include a first state and a second state, wherein the first state corresponds to a normal state and the second state corresponds to a failed or degraded state.

7. The system according to claim 1, wherein each state of the plurality of states is associated with a probability of occurrence based on fault information.

8. The system according to claim 1, wherein the data structure of the diagnostic model is created using information of the system, and wherein the information indicates hierarchical cause and effect relationships of failures between components of the system.

9. The system according to claim 1, wherein one or more nodes of the plurality of the nodes are associated with one or more conditional probabilities, wherein the one or more conditional probabilities are defined using conditional probability tables, and wherein the conditional probability tables are created based upon logic operations defined in a fault tree of the system.

10. The system according to claim 9, wherein the conditional probability tables defines the causal relationship from a parent node to a child node by determining a probability of occurrence for a respective transition from each state of the parent node to each state of the child node.

11. The system according to claim 1, wherein the processor is further configured to define a probability of occurrence for each state of a node of the diagnostic model.

12. The system according to claim 11, wherein the probability of occurrence is generated using historical knowledge, machine learning techniques, failure modes effects and criticality analysis (FMECA) information, probability of failure (POF) information, or a combination thereof.

13. The system according to claim 1, wherein the processor is further configured to determine whether the plurality of sensor measurements from each sensor is equal to or exceeds a predetermined limit.

14. The system according to claim 1, wherein the diagnostic model is constructed based on schematics of the system, failure modes effects and criticality analysis (FMECA) information, probability of failure (POF), or a combination thereof.

15. The system according to claim 1, wherein the system includes an air trim system of an aircraft.

16. A method for diagnosing faults of a system comprising:
receiving, by one or more processors, operational data associated with the system, wherein the operational data includes a plurality of sensor measurements for each sensor of a plurality of sensors of the system, and wherein the sensor measurements are indicative of conditions or states of the system;
comparing, by one or more processors, the plurality of sensor measurements from each sensor to a respective threshold value;
determining, based on the comparisons, a condition of the system having a degraded state and one or more conditions of the system having a normal state;
selecting, by the one or more processors, at least one of the one or more conditions of the system having a normal state;
inputting, by the one or more processors, the condition having degraded state and the at least one condition having a normal state into a diagnostic model, wherein the diagnostic model represents a data structure defining causal relationships between nodes, wherein the data structure includes a plurality of the nodes representing components of the system, and wherein each of the nodes includes a plurality of states;
isolating, using the diagnosis model, a failed or degraded component of the system; and
providing, by the one or more processors, a maintenance action for the failed or degraded component.

17. The method according to claim 16, further comprising:
receiving, by the one or more processors, maintenance information relating to the system;
determining, by the one or more processors, a maintenance condition based on the maintenance information;
inputting, by the one or more processors, the maintenance condition into the diagnostic model; and
isolating, using the diagnosis model, one or more failed or degraded components of the system.

18. The method according to claim 17, wherein the maintenance information includes a failure event or message, wherein the maintenance action identifies the one or more failed or degraded components of the system for replacement or repair, wherein the plurality of states include a first state and a second state, wherein the first state corresponds to a normal state and the second state corresponds to a failed state, and wherein each state of the plurality of states is associated with a probability of occurrence based on fault information.

19. The method according to claim 17, wherein the diagnostic model includes a Bayesian network.

20. A non-transitory computer-readable medium having stored thereon instruction code, wherein the instruction code is executable by a processor of a computer to perform operations comprising:
receiving operational data associated with a system, wherein the operational data includes a plurality of sensor measurements for each sensor of a plurality of sensors of the system, and wherein the sensor measurements are indicative of conditions or states of the system;
comparing the plurality of sensor measurements from each sensor to a respective threshold value;
determining a condition of the system having a degraded state and one or more conditions of the system having a normal state;
selecting at least one of the one or more conditions of the system having a normal state;
inputting the condition having degraded state and the at least one condition having a normal state into a diagnostic model, wherein the diagnostic model represents a data structure defining causal relationships between nodes, wherein the data structure includes a plurality of the nodes representing components of the system, and wherein each of the nodes includes a plurality of states;
isolating, using the diagnosis model, a failed or degraded component of the system; and
providing a maintenance action for the failed or degraded component.
